(19) United States
(12) Patent Application Publication
(10) Pub. No.: US 2018/0300872 A1
(43) Pub. Date: Oct. 18, 2018

(54) Method And Apparatus For Integrated Circuit Pattern Inspection With Automatically Set Inspection Areas

(71) Applicant: NGR Inc., Yokohama (JP)

(72) Inventors: Kazuto TANAKA, Yokohama (JP); Satoshi TERASAKI, Yokohama (JP)

(21) Appl. No.: 15/486,251

(22) Filed: Apr. 12, 2017

(51) Int. Cl. G06T 7/00; G06T 7/70; G06T 7/62

(52) U.S. Cl. CPC G06T 7/0006; G06T 2207/30148; G06T 7/62; G06T 7/70

(57) ABSTRACT

A method of setting inspection areas capable of reducing pattern inspection time of integrated circuit patterns by selecting areas where systematic defects are likely to occur. The method includes: extracting multiple pattern types from design data by grouping patterns contained in the design data in accordance with shape; selecting one type of pattern from the multiple pattern types; searching design data to identify patterns having same shape as the selected type of pattern; and registering positions of identified patterns as sampling points.

### FIELD OF THE INVENTION

The present invention relates to an apparatus and method of pattern inspection of integrated circuit wafers and/or masks, using automatically set inspection areas. More particularly the pattern inspection apparatus and method is useful for inspecting fine patterns of photolithographically-produced devices including semiconductor integrated circuits (or LSI), optoelectronic devices, liquid crystal panels, and the photomasks or reticles from which they are made.

### BACKGROUND

An optical pattern inspection apparatus using die-to-die comparison has been used for wafer pattern inspections in a semiconductor integrated circuit manufacturing process, or for pattern inspection of photomasks used to form wafer patterns. Die-to-die comparison detects defects by comparing images of a first semiconductor device, the die to be inspected, with images obtained at the same position in a second, or reference, die. In some systems the reference die and die to be inspected are adjacent. Die-to-die inspection typically can detect defects, such as random defects caused by particle contamination that appear on one or more die but not on all die; die-to-die inspection may miss defects from systemic causes that affect all die of a wafer or mask.

For inspection of a photomask or reticle having no adjacent die; a die-to-database comparison method is used. In die-to-database comparison, mask data are converted into a mask data image. The mask data image is then substituted for the image of the reference die of the die-to-die comparison method, and inspection is performed by comparing images of the die-to-be-inspected and the mask data image. The mask data may include data obtained by applying photomask corrections to design data. Die-to-database inspection is disclosed, for example, in U.S. Pat. No. 5,563,702, “Automated photomask inspection apparatus and method.”

From a viewpoint of problems in semiconductor integrated circuit fabrication, repeated or systemic defects are a more important issue than random defects caused by a particle or the like. Systematic defects are defects that occur repeatedly over all dies on a wafer caused by photomask failure, processing anomalies, holes in background areas of a reticle, or the like. Because systematic defects occur both in a die to-be-inspected and in adjacent reference dies, die-to-die comparison wafer inspection cannot detect such systematic defects. Accordingly, the die-to-database comparison wafer inspection is required.

In wafer inspection, it is desirable to inspect the entirety of dies to be inspected. However, although the die-to-database comparison method is a high-precision inspection technique, it is slow when using a scanning electron microscope (SEM), and SEM inspection is required to give the resolution necessary for inspecting die fabricated with modern fine-line semiconductor processes. For this reason, in die-to-database comparison, the inspection areas are limited to a part of each die.

Setting of the inspection areas has been conducted manually based on experiences of an engineer. Accordingly, it is possible that one or more critical defects exist in an area outside the inspection area and thus escapes detection.

There is a proposed method that solves the above drawback by analyzing the design data and inspecting different types of patterns while avoiding inspecting the same type of patterns. This is based on the fact that patterns of the same type are expected to have the same type of defect.

For example, “Inspection area setting method, inspection area setting apparatus, and computer program product” (U.S. published patent application 20110013824) (document 1) discloses extracting patterns from multiple sampling positions in design layout data; classifying the extracted patterns into multiple types fewer than a number of the extracted patterns based on similarity of geometric feature attributes; and setting a candidate area including a largest number of types of the patterns classified. However, document 1 does not describe how to select the sampling positions and does not describe a specific way to classify the extracted patterns. “Design-based method for grouping systematic defects in lithography pattern writing system” (U.S. Pat. No. 7,760,347) (document 2) discloses a method of grouping potential systematic defects based on the design data.

There is a general technique in which sampling points are arranged at equal intervals. However, grouping results of this method may include pattern areas with no relation to likely systematic defects. Such grouping results in an increase in useless inspections, and moreover entails an increase in grouping time. Accordingly, the present invention selects more appropriate sampling points.

### SUMMARY

According to an embodiment of the present invention, there is provided a method of reducing an inspection time by selecting only areas where the systematic defect is likely to occur. In an embodiment, this is done by using a method of setting inspection areas, including: extracting plural types of polygons from design data by grouping patterns contained in the design data in accordance with shapes; selecting one type of polygon from the plural types of polygons; searching the design data to identify polygons having the same shape as that of the selected one type of polygon; and registering positions of the identified polygons as sampling points.

In a particular embodiment, the step of selecting one type of polygon includes: comparing minimum line widths of the plural types of polygons with a line width threshold value; and selecting one type of polygon having a minimum line width smaller than the line width threshold value from the plural types of polygons.

In another embodiment, a polygon inspection apparatus includes a processor and a scanning electron microscope, the processor having machine readable instructions configured to input integrated circuit design data comprising a plurality of polygons; and to set inspection areas by: extracting a plurality of types of polygons from design data by grouping polygons contained in the design data in accordance with shape of each polygon; selecting a first type of polygon from the plurality of types of polygons; searching the design data to identify polygons having the same shape as that of the selected first type of polygon; and registering positions of the identified polygons as sampling points. The instructions further comprise instructions configured to obtain scanning electron microscope images of the inspection areas in a pattern to be inspected; and compare shapes of the obtained scanning electron microscope images with the design data in the inspection areas.

According the above-described embodiments of the present invention, the sampling points, which are limited to areas where a systematic defect is likely to occur, are obtained, and as a result, the inspection time is shortened. The above-described embodiments of the present invention can be applied to any type of inspection, such as pattern inspection, of integrated circuit design data to fabricated patterns.

### BRIEF DESCRIPTION OF THE DRAWINGS

FIG. 1 is a block diagram showing an embodiment of a pattern inspection apparatus.

FIG. 1A is a block diagram illustrating the processor, memory, and interface to the SEM of a pattern inspection system.

FIG. 2 is a schematic diagram of an embodiment of an image generation device of the pattern inspection apparatus.

FIG. 3 is a flow chart showing an embodiment of a method for setting inspection-areas for pattern inspection on the apparatus of FIG. 1.

FIG. 3A is a flow chart illustrating an alternative embodiment of the method for setting inspection areas for pattern inspection on the apparatus of FIG. 1.

FIG. 4 is a schematic diagram showing step 1 of the flow chart shown in FIG. 3.

FIG. 5 is a schematic diagram showing step 2 of the flow chart shown in FIG. 3.

FIG. 6 is a schematic diagram showing step 3 of the flow chart shown in FIG. 3.

FIG. 7 is a schematic diagram showing step 4 of the flow chart shown in FIG. 3.

FIG. 8 is a schematic diagram showing step 6 of the flow chart shown in FIG. 3.

FIG. 9 is a diagram showing all of registered sampling points covered with masks; and

FIG. 10 is a schematic diagram showing an embodiment of a method of determining whether shapes of polygons are the same as each other.

### DETAILED DESCRIPTION OF THE EMBODIMENTS

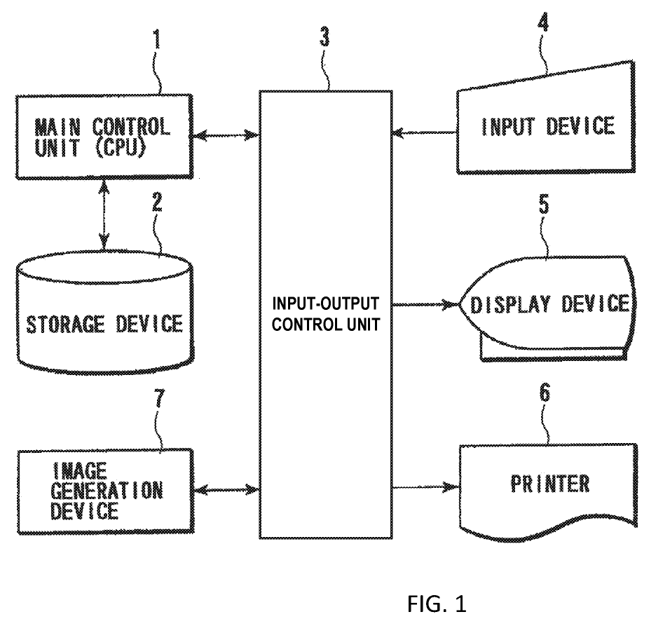

FIG. 1 is a block diagram showing an embodiment of a pattern inspection apparatus. This pattern inspection apparatus has a main control unit 1 incorporating a processor and internal memory, a storage device 2, an input/output control unit 3 of which only part is shown, an input device 4, a display device 5, a printer 6, and an image generation device 7.

The main control unit 1 includes a processor with one or more CPUs (Central Processing Unit) and local memory, and manages and controls the whole pattern inspection apparatus under control of software stored in storage device 2. The main control unit 1 is coupled to the storage device 2. The storage device 2 may be in the form of one or more of a hard disk drive, a flexible disk drive, a solid state disk, an optical disk drive, or other memory devices. The input device 4 such as a keyboard and a mouse with display device 5 such as a display for displaying input data, calculation parameters, and the like, and the printer 6 for printing calculation results. Locations of inspection areas, locations of faults, fault measurements, and other data are coupled to the main control unit 1 through the input/output control unit 3. In addition, control unit 1 may in some embodiments be coupled via a network to a network storage system from which design data may be read, and locations of inspection areas, locations of faults, fault measurements and fault statistics may be stored, and other data useful for inspection may be read or stored.

The main control unit 1 internal memory stores a control program such as an OS (Operating System), a program for the pattern inspection and extraction of sampling points, necessary data, and other data and programs. The main control unit 1 is configured by these programs to perform pattern inspection and the extraction of inspection regions. These programs can be initially stored in a flexible disk, an optical disk, USB-drive, or other media, read from that media and stored in a RAM memory, solid state disk, a hard disk, or other memory before execution, and then executed by one or more processors of main control unit 1.

FIG. 1A is a detailed block diagram of the main control unit 1, of FIG. 1 and associated components including storage 2. Main control unit 1, 102 has one or more processors 104 and a local, fast, memory 106 typically including cache SRAM and DRAM as known in the art. Memory 106 includes an operating system 108 kernel, an design-data input routine 110, and a routine for setting inspection areas 112. Processors 104 couple through an internal bus and a network interface 114 to external network storage 116. Processors 104 also couple to a SEM interface 120 and to the image generation device 7 or SEM 120. Processors 104 also couple to a local storage interface 122. Local storage interface 122 in turn has a port for a USB drive 124 and to a local storage 126. Local storage 126 contains virtual memory storage as set up by the operating system 108, executable operating system files and copies of routines, including routines 110, 112, adapted for execution on processors 104.

In a typical embodiment, a pattern inspection session begins with design data input routine 110 executing on processors 104 to read design data from the USB drive 124 or from network storage 116 to a local design data copy 132. The design data input routine then reads polygons of local design data copy into design data shapes 136. The routine for setting inspection areas 112 uses the design data shapes to generate inspection regions 138, these inspection regions 138 may in some embodiments be saved for future sessions in inspection regions 134.

Once inspection regions 138 are generated, a design data image creation routine 142 executes, using design data shapes 136 to construct a design data image 144. In some embodiments design data image 144 is a complete image of the layer to be inspected, in other embodiments design data image 144 includes only shapes within inspection regions 130 and is thus a partial image. Processors 104 also execute wafer handling routines 140 to instruct image generation device 7 to load a wafer or mask into the scanning electron microscope 120 and position a die for inspection, SEM imaging routine 146 and alignment function 147 are executed on processors 104 to use the SEM 120 to build an SEM data partial image 148 of inspection regions on a die on the wafer or mask. Pattern comparison routines 150 then execute to perform the inspection. Any issues found during the inspection are logged by pattern problem logging and statistical analysis routines 152, which records problems found and statistics in inspection results 154 on local storage 128. SEM imaging routines 146, pattern comparison 150, and logging and statistical analysis 152 routines may then be re-executed for any additional die on the wafer or masks, and, together with wafer handling routines 140, to inspect additional die on other wafers or masks. Inspection results 154 may then be viewed on display device 5.

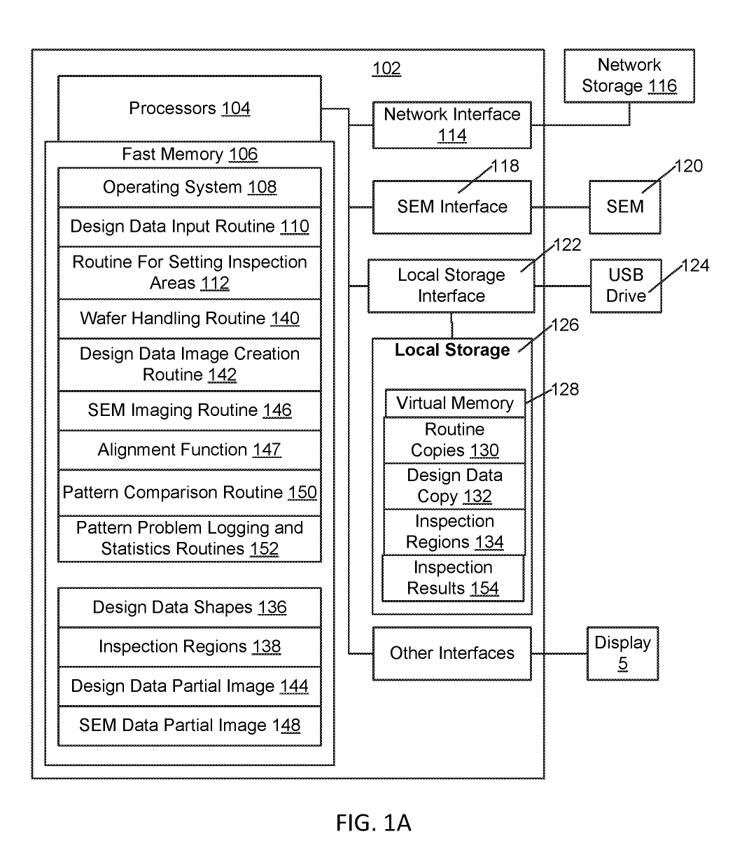

FIG. 2 is a schematic diagram of an embodiment of a scanning electron microscope (SEM) image generation device 7 of the pattern inspection apparatus. As shown in FIG. 2, the image generation device 7 includes an electron irradiation system 10, a specimen chamber 20, and a secondary electron detector 30. In this embodiment, the image generation device 7 comprises a scanning electron microscope.

The electron irradiation system 10 of the SEM includes an electron gun 11 adapted to provide an electron beam, a focusing lens 12 for focusing primary electrons emitted from electron gun 11, an X deflector 13 and a Y deflector 14 for deflecting the electron beam (charged-particle beam) in the X direction and the Y direction, respectively, and an objective lens 15. The specimen chamber 20 has an XY stage 21 which is movable in the X direction and the Y direction. A wafer W, including a specimen pattern to be inspected, can be loaded into and unloaded from the specimen chamber 20 by a wafer-loading device 40.

In the irradiation system 10, primary electrons, emitted from the electron gun 11, are focused by the focusing lens 12, deflected by the X deflector 13 and the Y deflector 14, and focused and applied by the objective lens 15 to the surface of the wafer W.

When the primary electrons strike the pattern to be inspected on wafer W, wafer W emits secondary electrons. These secondary electrons are detected by the secondary electron detector 30. The focusing lens 12 and the objective lens 15 are coupled to a lens controller 16, which is coupled to a control computer 50. The secondary electron detector 30 is coupled to an image acquisition device 17, which is also coupled to the control computer 50. Intensity of the secondary electrons detected by the secondary electron detector 30 is converted into an image of a pattern to-be-inspected by the image acquisition device 17. A field of view is defined as the largest region where the primary electrons are applied and an image without distortion can be acquired.

The X deflector 13 and the Y deflector 14 are coupled to a deflection controller 18, which is also coupled to the control computer 50. The XY stage 21 is coupled to an XY stage controller 22. This XY stage controller 22 is also coupled to the control computer 50. The wafer-loading device 40 is also coupled to the control computer 50. The control computer 50 is coupled to a console computer 60.

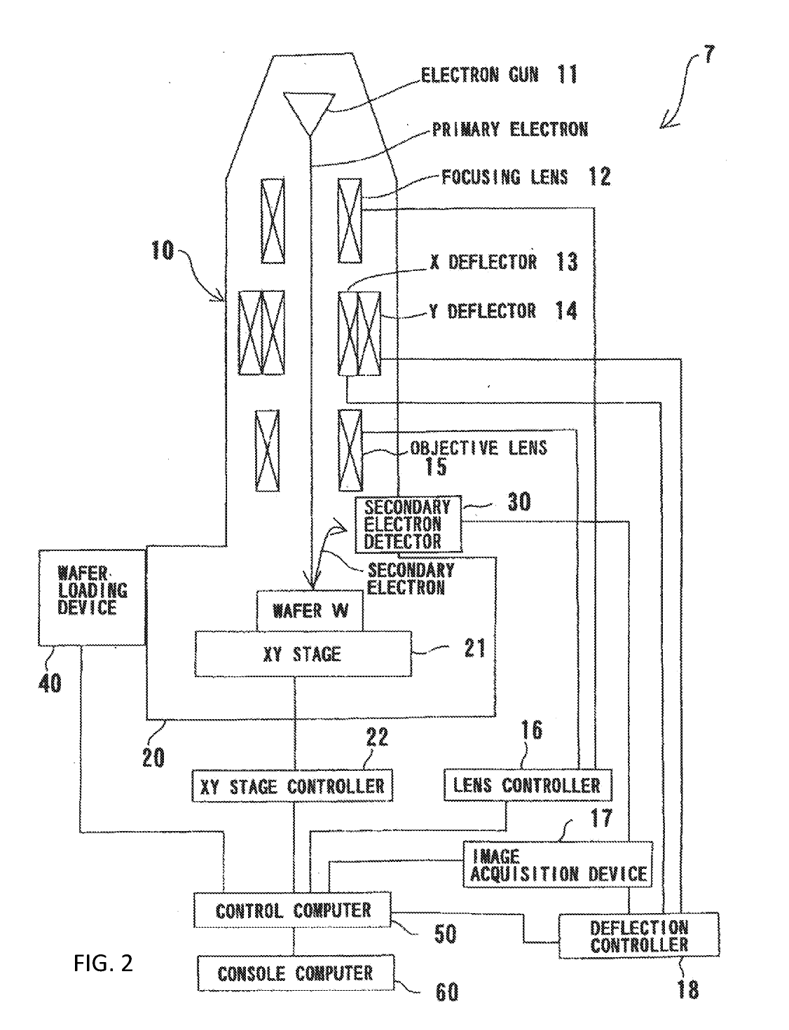

FIG. 3 is a flowchart of a method of setting inspection areas for a pattern inspection according to an embodiment of the present invention. The method of setting inspection areas is carried out by the main control unit 1 shown in FIG. 1 prior to performing pattern inspection. First, the main control unit 1 obtains shape data of polygons from design data, and groups these according to their shape, thereby extracting multiple polygon shapes from the design data (step 1). Then, the main control unit 1 determines whether minimum line widths of each polygon shape (or polygon type) are smaller than a preset threshold value (step 2) to determine polygon types where certain defect types are possible. If the minimum line widths of all of the polygon types are equal to or greater than the threshold value, then the processing flow is ended. If not, then the processing flow goes to step 3.

In step 3, the main control unit 1 selects a polygon type which has a minimum line width smaller than the threshold value. The main control unit 1 searches the identifies all polygons in the design data having the same shape as the polygon selected in step 3, and registers positions of the identified polygons as sampling points (step 4). If all types of polygons having minimum line widths smaller than the threshold value, have been identified and registered, then the processing flow is ended (step 5). If not, then the processing flow goes to step 6.

The main control unit 1 covers all of the registered sampling points with respective masks, calculating a total area of all of the masks with overlap areas counted only once in the total, and determines whether a proportion of the total area of the masks to an area of the design data is smaller than a preset threshold value (step 6). If the calculated proportion is equal to or greater than the threshold value, then the processing flow is ended. If not, then the processing flow goes back to step 3.

In the alternative embodiment 300 of FIG. 3A, polygons are imported 301 and classified 303 according to shape. Each group of polygons having the same shape are considered as being of the same type, with polygons having other shapes being of different types.

Polygon types are then sorted 307 according to the minimum line width in polygons of that type. Polygons of each minimum line width are further sorted according to complexity. The polygon type having the smallest minimum line width and greatest complexity 307 is selected.

In determining complexity, a count of vertexes of the polygon is made. Complexity is assumed to equal the number of vertexes in the polygon.

If 309 the minimum line width of that polygon is above a threshold, processing ceases 311. Otherwise, the polygons sorted as being of this type are placed 313 in the sampling points list, and masks 315 are placed around these polygons. Area of the masks is then totalized 317, counting overlap areas only once. If the total area of masks exceeds 319 a threshold, processing ceases 311; otherwise the shape type with the next largest greatest complexity at the present line width is selected 321. If no further shapes having the same line width remain, the most complex shape type with next greater line width is selected.

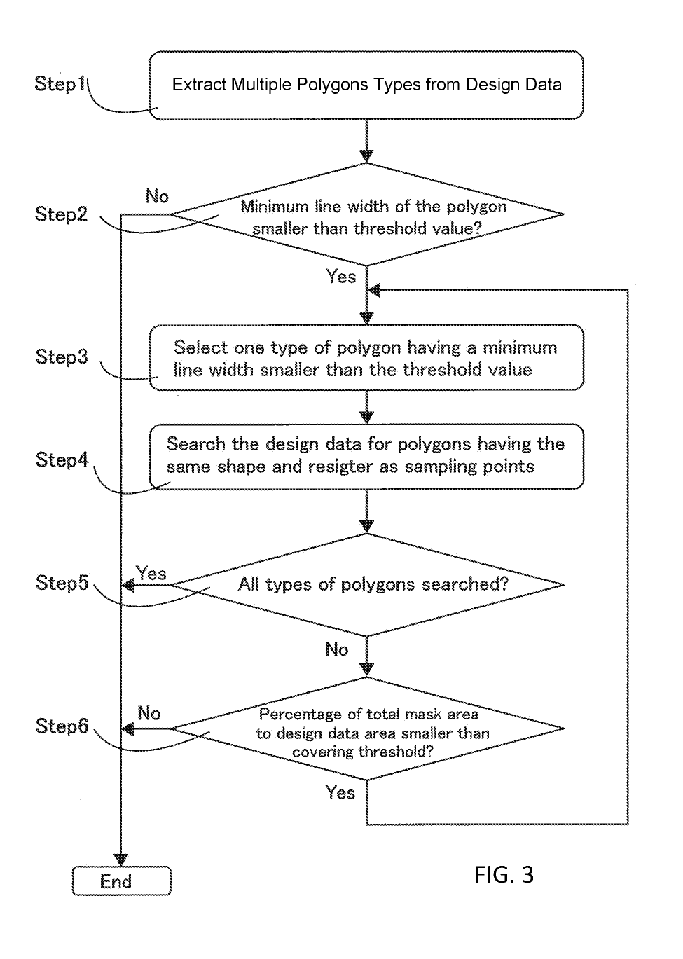

FIG. 4 is a conceptual view illustrative of step 1 shown in FIG. 3. Design data 70 serve as a design diagram including plural types of patterns represented by polygons 74c, 74d, 74e, such as patterns of interconnects, gates, transistors, etc. Each of the polygons 74c, 74d, 74e may be an independent pattern having no fragmentary shape. Stated otherwise, plural types of patterns, represented by polygons 74c, 74d, 74e, exist in a rectangular region that constitutes the design data 70. The main control unit 1 reads the design data 70 through the input device 4, and extracts all types of polygons 71, 72, 73 having different shapes from the design data 70, where polygons 74c extract as polygons 73, polygons 74d extract as polygons 71, and polygons 74e extract as polygons 72.

Generally, the design data include a plurality of polygons having different shapes. The main control unit 1 (see FIG. 1) extracts plural types of polygons 71, 72, 73 having different shapes from the design data 70 by grouping or classifying all of the polygons 74c, 74d, 74e existing in the design data 70 according to their shapes. In the embodiment shown in FIG. 4, three types of polygons 71, 72, 73 are extracted from the design data 70. The main control unit 1 obtains shape data of these polygons 71, 72, 73. The shape data refer to data representing relative positions of vertexes of each polygon. Specifically, the shape data include coordinates of the vertexes of each of the polygons.

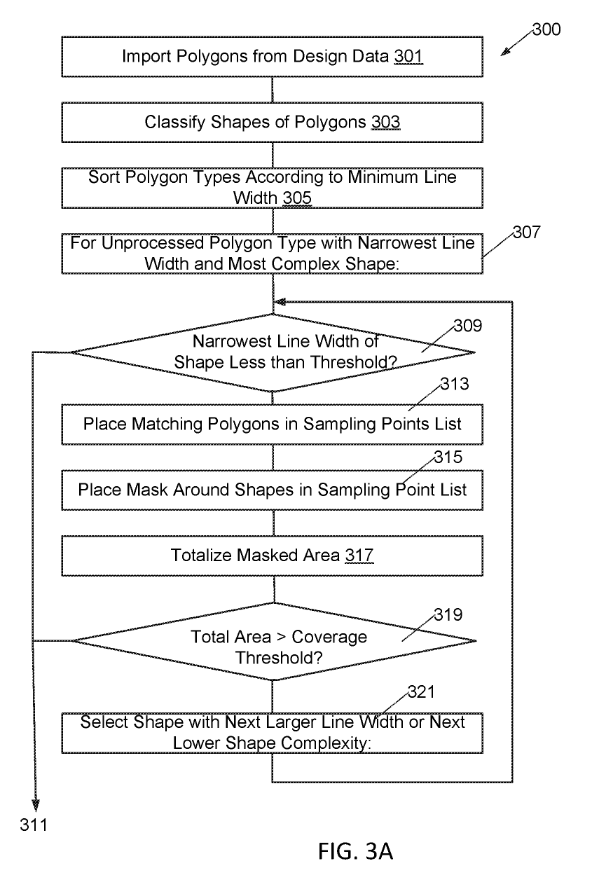

FIG. 5 is a conceptual view illustrative of step 2 shown in FIG. 3. The main control unit 1 determines respective minimum line widths W1, W2, W3 of the extracted polygons 71, 72, 73, compares the minimum line widths W1, W2, W3 with a preset line width threshold value, and determines whether the minimum line widths W1, W2, W3 are smaller than the line width threshold value. The minimum line widths W1, W2, W3 are calculated from the corresponding coordinates of the polygons 71, 72, 73.

In the embodiment shown in FIG. 5, the minimum line widths W1, W2 of the polygons 71, 72 are smaller than the line width threshold value, whereas the minimum line width W3 of the polygon 73 is greater than the line width threshold value. Therefore, the main control unit 1 determines that polygons 71, 72 have minimum line widths less than threshold. Similarly, main control unit 1 determines polygon 73 has a minimum line width greater than threshold. The reason for this thresholding operation is that a polygon whose minimum line width is large is expected to be free of opens type defects, allowing focus inspection on other polygons more likely to have opens type defects.

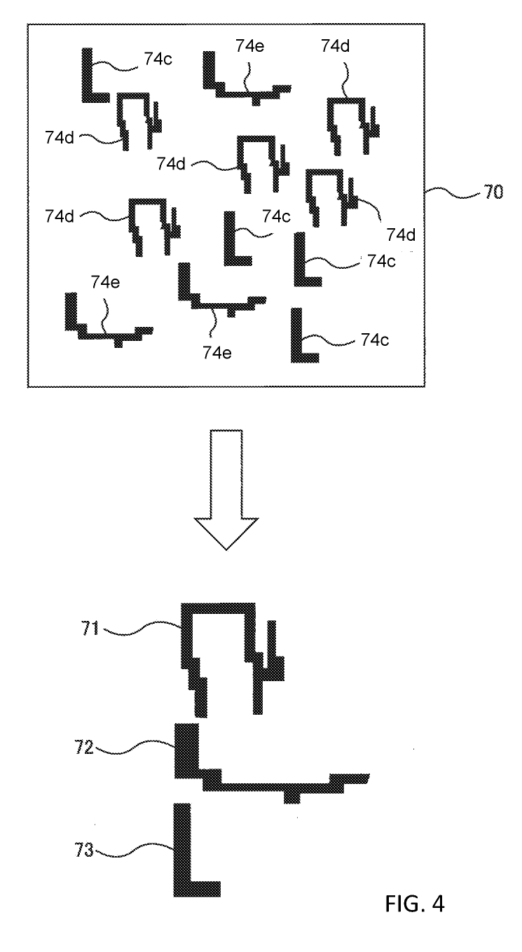

FIG. 6 is a conceptual view illustrative of step 3 shown in FIG. 3. The main control unit 1 selects one type of polygon 71 whose minimum line width is smaller than the line width threshold value.

The minimum line width is a shape index value indicating the possibility of a defect due to a shape of a polygon. In one embodiment, the number of vertexes of a polygon or a perimeter of a polygon is used as a second shape index value. A polygon having many vertexes indicates that the polygon has a complex shape and such polygons are more likely to have a defect. In one embodiment, the main control unit 1 determines the number of vertexes of each of the polygons 71, 72, 73, compares the number of vertexes with a preset vertex-count threshold value, and selects one type of polygon whose number of vertexes is greater than the vertex threshold value.

Similarly, a polygon having a long perimeter indicates that such a polygon has a complex shape and that the polygon is more likely to have a defect. In an embodiment, the main control unit 1 determines the perimeter of each of the polygons 71, 72, 73, compares the perimeter with a preset perimeter threshold value, and selects one type of polygon whose perimeter is greater than the perimeter threshold value.

In an embodiment, the main control unit 1 compares the minimum line widths of the polygons, the numbers of vertexes of the polygons, and the perimeters of the polygons with the line width threshold value, the vertex threshold value, and the perimeter threshold value, respectively.

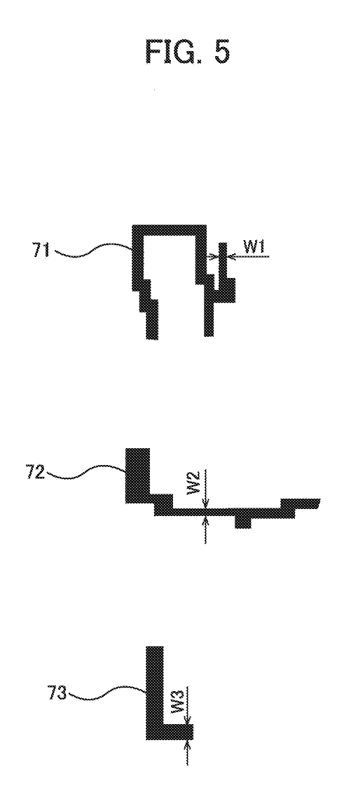

FIG. 7 is a conceptual view illustrative of step 4 shown in FIG. 3. The main control unit 1 (see FIG. 1) searches the design data 70 to identify polygons 74d which have the same shape as that of the selected polygon 71. 74d The main control unit 1 registers positions (absolute positions) of the polygons 74d as sampling points 80. The positions of the sampling points 80 are represented by coordinates in a two-dimensional coordinate system predefined on the design data 70.

If the searching process and the registration of sampling points 80 have been completed with respect to all of the polygons that have been selected in the step 2, i.e., the plural types of polygons 71, 72 which have minimum line widths smaller than the line width threshold value, then the processing flow is ended (step 5). In the example shown in FIGS. 6 and 7, since the searching process and the registration of sampling points 80 have not been performed yet with respect to the polygon 72, the processing flow goes to step 6.

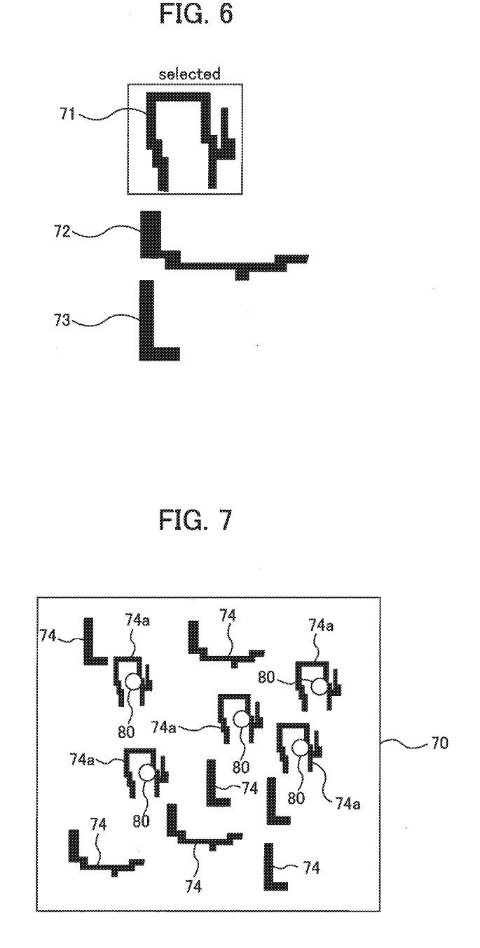

FIG. 8 is a conceptual view illustrative of step 6 shown in FIG. 3. The main control unit 1 covers all of the registered sampling points 80 with masks 85, respectively. All of the masks 85 have the same size and the same shape. The masks 85 are not physical masks, and are virtual masks. In this embodiment, the marks 85 are of a square shape, while the masks 85 may be of another shape, such as a circular shape. The masks 85 are placed on the sampling points 80 according to predetermined rules. Specifically, a relative position of each sampling point 80 and its corresponding mask 85 is constant. In one embodiment, the masks 85 are placed on the sampling points 80 such that the centers of the masks 85 coincide with the centers of the sampling points 80, respectively.

The main control unit 1 calculates the total area of all of the masks 85 excluding overlapping areas between masks 85. In FIG. 8, the total area is represented by an area of regions surrounded by thick dotted lines. The main control unit 1 calculates a proportion (%) of the total area to an area of the design data 70, i.e., an area of a rectangular design diagram that constitutes the design data 70. If the calculated proportion of selected inspection areas to total design data area is equal to or greater than a preset covering threshold value, then the processing flow is ended. If the calculated proportion is smaller than the covering threshold value, then the processing flow goes back to step 3, and steps 3 through 6 are repeated.

When step 3 is carried out again, polygons 71 that have already been selected are not selected. According to the present embodiment, the polygon 72, other than the polygon 71, has a minimum line width smaller than the line width threshold value. Consequently, the main control unit 1 selects the polygon 72 in step 3. Then, as described above, steps 4 through 6 are carried out again.

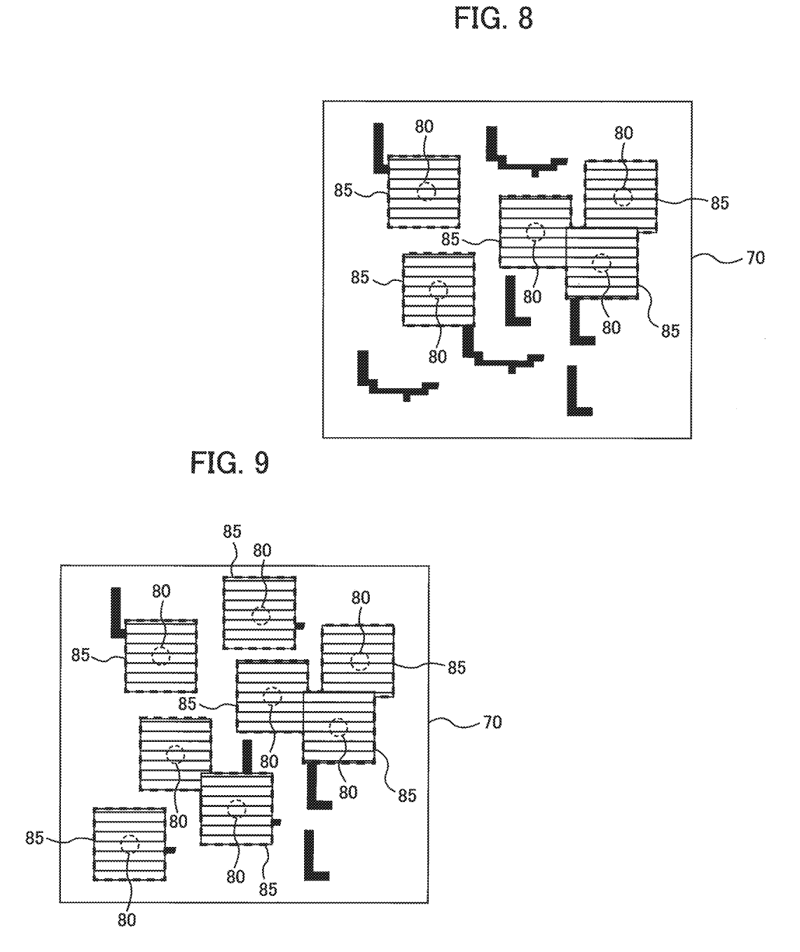

FIG. 9 is a diagram showing a state in which polygons 71, 72 are registered as the sampling points 80 and the registered sampling points 80 are covered with the masks 85. The main control unit 1 calculates the total area of all of the masks 85 (excluding the overlapping areas between the masks 85). Then, the main control unit 1 calculates the proportion (%) of the total area of masks 85 to the area of the region that represents the design data 70 (i.e., the area of the rectangular design diagram). If the calculated proportion is equal to or greater than the preset covering threshold value, then the processing flow is ended. If the calculated proportion is smaller than the covering threshold value, then the processing flow goes back to step 3 again.

If the covering threshold value increases, steps 3 through 6 are more likely to be repeated. As a result, the number of sampling points 80 becomes larger, thus improving the accuracy of a pattern inspection. On the other hand, if the covering threshold value decreases, steps 3 through 6 are less likely to be repeated. As a result, the number of sampling points 80 becomes smaller, resulting in a reduction in the time of the pattern inspection. The covering threshold value is determined in advance by weighing the pattern inspection accuracy and the pattern inspection time.

According to the present embodiment, regions where there is a possibility of systematic defects, i.e., sampling points 80, are identified on the design data 70. Therefore, the pattern inspection apparatus is able to focus on the pattern inspections in the sampling points 80.

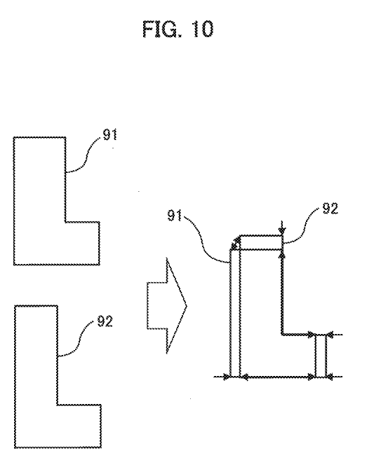

FIG. 10 illustrates a method of determining whether the shapes of polygons are the same, which is carried out in step 4, according to an embodiment of the present invention. In the embodiment of FIG. 10, shapes of a first polygon 91 and a second polygon 92 are compared with each other. The main control unit 1 superimposes the first polygon 91 onto the second polygon 92. The main control unit 1 then calculates a distance between each of vertexes of the first polygon 91 and the nearest one of vertexes of the second polygon 92 to determine distances between the vertexes of the first polygon 91 and corresponding vertexes of the second polygon 92, and determines whether all of the determined-distances-are smaller than a set value. If the determined distances are smaller than the set value, then the main control unit 1 determines that the shapes of the first polygon 91 and the second polygon 92 are the same.

FIG. 10 illustrates a method of determining whether the shapes of polygons are the same, which is carried out in step 4, according to an embodiment of the present invention. In the embodiment of FIG. 10, shapes of a first polygon 91 and a second polygon 92 are compared with each other. The main control unit 1 subtracts an origin 95 of the first polygon 91 from an origin 93 of the second polygon 92 to determine an offset, and subtracts the offset from vertexes of the second polygon 92 to determine vertexes of a transposed polygon 94 resembling the second polygon transposed to align with vertexes of the first polygon. The main control unit then calculates distances between vertexes of the first polygon 91 and corresponding vertexes of the transposed polygon 92, and determines whether the calculated distances 96, 97 are smaller than a set value. Specifically, if the calculated distances are smaller than the set value, then the main control unit 1 determines that the shapes of the first polygon 91 and the second polygon 92 are the same.

Before the shapes of the first polygon 91 and the second polygon 92 are compared with each other, either the first polygon 91 or the second polygon 92 may be rotated, inverted, translated, scaled up, and/or scaled down.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method of setting inspection areas in a pattern inspection apparatus, comprising:
extracting a plurality of types of polygons from design data by grouping polygons contained in the design data in accordance with shapes of the polygons;
selecting a first type of polygon from the plurality of types of polygons;
searching the design data to identify polygons having the same shape as that of the selected first type of polygons; and
registering positions of the identified polygons as sampling points.

2. The method according to claim 1, wherein said selecting the first type of polygon comprises:
comparing minimum line widths of the plurality of types of polygons with a line width threshold value; and
selecting the first type of polygon as a polygon having minimum line width smaller than the line width threshold value.

3. The method according to claim 2, wherein said selecting the first type of polygon further comprises selecting a polygon having a maximal vertex count of polygons having a particular minimum line width.

4. The method according to claim 2, wherein said selecting the first type of polygon comprises:
comparing perimeters of the plurality of types of polygons with a perimeter threshold value; and
selecting a first type of polygon having a perimeter greater than the perimeter threshold value from the plurality of types of polygons.

5. The method according to claim 1, further comprising:
covering the sampling points with masks, respectively;
calculating a proportion of a total area of the masks to an area of a design diagram that constitutes the design data; and
if the proportion is smaller than a covering threshold value, repeating said selecting a first type of polygon, said identifying polygons, said registering sampling points, and said covering sampling points with masks.

6. The method according to claim 1, wherein, if differences between vertexes of the first type of polygon and corresponding vertexes of a second polygon to be compared are smaller than a preset value after transposing the second polygon onto the first type of polygon, the polygon to be compared is determined to have the same shape as that of the one type of polygon.

7. A pattern inspection apparatus comprising a processor and a scanning electron microscope, wherein the processor comprises machine readable instructions configured to:
input integrated circuit design data comprising a plurality of polygons;
set inspection areas by:
extracting a plurality of types of polygons from design data by grouping polygons contained in the design data in accordance with a shape of each polygon;
selecting a first type of polygon from the plurality of types of polygons;
searching the design data to identify polygons having the same shape as that of the selected first type of polygon; and
registering positions of the identified polygons as sampling points;
obtain scanning electron microscope images of the inspection areas in a pattern to be inspected; and
comparing shapes of the obtained scanning electron microscope images with the design data in the inspection areas.

8. The apparatus according to claim 7, wherein the machine readable instructions for said selecting a first type of polygon comprise instructions configured to:
compare minimum line widths of the plural types of polygons with a line width threshold value; and
select the first type of polygon as a polygon having a minimum line width smaller than the line width threshold value from the plurality of types of polygons.

9. The apparatus according to claim 7, wherein the machine readable instructions for selecting a first type of polygon comprise instructions configured to:
compare the number of vertexes of each of the plurality of types of polygons with a vertex threshold value; and
select the first type of polygon as a polygon having a number of vertexes greater than the vertex threshold value from the plurality of types of polygons.

10. The apparatus according to claim 7, wherein the machine readable instructions for selecting a first type of polygon comprises instructions configured for:
comparing perimeters of the plurality of types of polygons with a perimeter threshold value; and
selecting the first type of polygon as a polygon having a perimeter greater than the perimeter threshold value from the plurality of types of polygons.

11. The apparatus according to claim 7, wherein the machine readable instructions for selecting inspection areas further comprise instructions configured to perform:
covering the sampling points with masks, respectively;
calculating a proportion of a total area of the masks to an area of a design diagram that constitutes the design data; and
if the proportion is smaller than a covering threshold value, repeating said selecting a first type of polygon, said identifying polygons, said registering sampling points, and said covering sampling points with masks.

12. The apparatus according to claim 7, wherein if differences between vertexes of the first type of polygon and corresponding vertexes of a second polygon to be compared and translocated to superimpose the second polygon's origin on an origin of the first type of polygon are smaller than a preset value, the pattern to be compared is determined to have the same shape as that of the first type of polygon.

13. The pattern inspection apparatus of claim 7, wherein the machine readable instructions for said selecting a first type of polygon comprise:
comparing minimum line widths of the plural types of polygons with a line width threshold value; and
selecting the first type of polygon as a polygon having a minimum line width smaller than the line width threshold value from the plurality of types of polygons.

14. The pattern inspection apparatus according to claim 7, wherein the machine readable instructions for selecting a first type of polygon comprise instructions configured to:
compare the number of vertexes of each of the plurality of types of polygons with a vertex threshold value;
compare perimeters of the plurality of types of polygons with a perimeter threshold value; and
select the first type of polygon as a polygon having the number of vertexes greater than the vertex threshold value from the plurality of types of polygons and having a perimeter greater than the perimeter threshold value from the plurality of types of polygons.
